(19) United States
(12) Patent Application Publication
(10) Pub. No.: US 2016/0034608 A1
(43) Pub. Date: Feb. 4, 2016

(54) UPDATING A BUILDING INFORMATION MODEL

(71) Applicant: Trimble Navigation Limited, Sunnyvale, CA (US)

(72) Inventor: Jean-Charles Delplace, Longueil Sainte Marie (FR)

(21) Appl. No.: 14/448,381

(22) Filed: Jul. 31, 2014

(51) Int. Cl. G06F 17/50

(52) U.S. Cl. CPC G06F 17/5004

(57) ABSTRACT

A method for updating a building information model with crane operations data is disclosed. The method includes: accessing data associated with operations of a crane, wherein the data relates to an object being moved by the crane; based on accessed data, generating timeline information, wherein the timeline information relates to the operations of the crane, the operations associated with a construction project; and automatically sending generated timeline information to the building information model.

### BACKGROUND

Lifting devices, such as cranes, are employed to hoist or lift objects to great heights. The lifting device may be employed at a location such as a construction site. The construction site may have many different objects and types of objects or assets associated with the construction type such as equipment, beams, lumber, building material, etc. The objects may or may not be moved by the lifting device. The crane may swivel or pivot about a pivot point to allow the crane to lift and move objects into position. Decisions are made regarding lift schedules and lift priorities based upon a totality of the information available. Presently, there exist limitations as to providing and/or receiving the most up-to-date crane operations information.

### BRIEF DESCRIPTION OF THE DRAWINGS

The accompanying drawings, which are incorporated in and form a part of this application, illustrate and serve to explain the principles of embodiments in conjunction with the description. Unless noted, the drawings referred to this description should be understood as not being drawn to scale.

FIGS. 1A and 1B are block diagrams of a tower crane system and a luffer crane, respectively, in accordance with embodiments of the present technology.

FIG. 2 is a block diagram of an environment with a crane, in accordance with an embodiment of the present technology.

FIG. 3 is a block diagram of a building model updater, in accordance with an embodiment of the present technology.

FIG. 4 is a block diagram of a building model updater, in accordance with an embodiment of the present technology.

FIG. 5 is a flowchart of a method for updating a building information model with crane operations data, in accordance with an embodiment of the present technology.

FIG. 6 is a block diagram of an example computer system upon which embodiments of the present technology may be implemented.

FIG. 7 is a block diagram of an example global navigation satellite system (GNSS) receiver which may be used in accordance with embodiments of the present technology.

### DESCRIPTION OF EMBODIMENT(S)

Reference will now be made in detail to various embodiments of the present technology, examples of which are illustrated in the accompanying drawings. While the present technology will be described in conjunction with these embodiments, it will be understood that they are not intended to limit the present technology to these embodiments. On the contrary, the present technology is intended to cover alternatives, modifications and equivalents, which may be included within the spirit and scope of the present technology as defined by the appended claims. Furthermore, in the following description of the present technology, numerous specific details are set forth in order to provide a thorough understanding of the present technology. In other instances, well-known methods, procedures, components, and circuits have not been described in detail as not to unnecessarily obscure aspects of the present technology.

Unless specifically stated otherwise as apparent from the following discussions, it is appreciated that throughout the present description of embodiments, discussions utilizing terms such as “accessing”, “generating”, “sending”, “organizing”, “integrating”, “time stamping”, or the like, often refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer systems such as, for example, mobile communication devices.

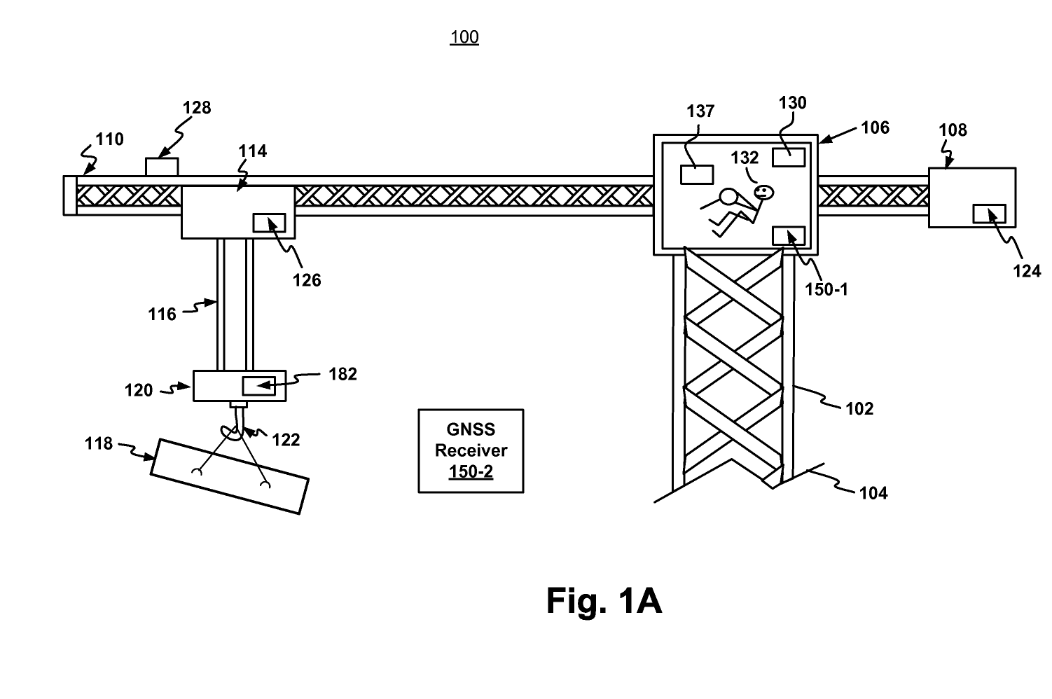

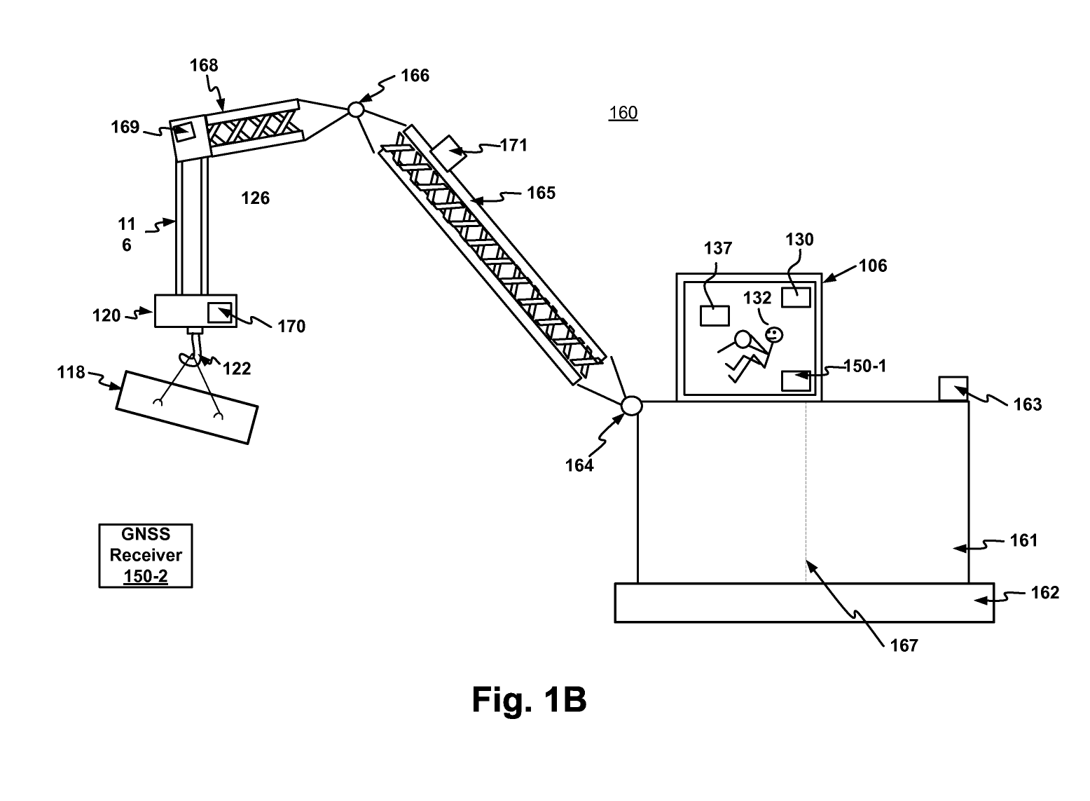

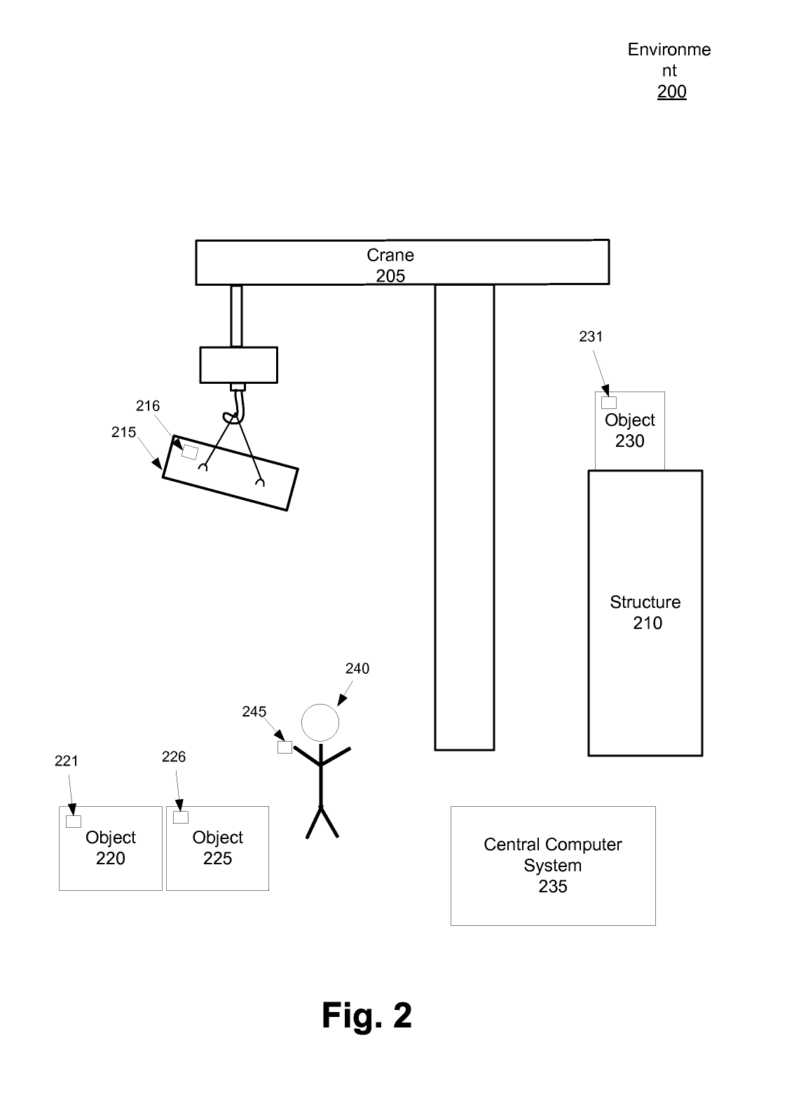

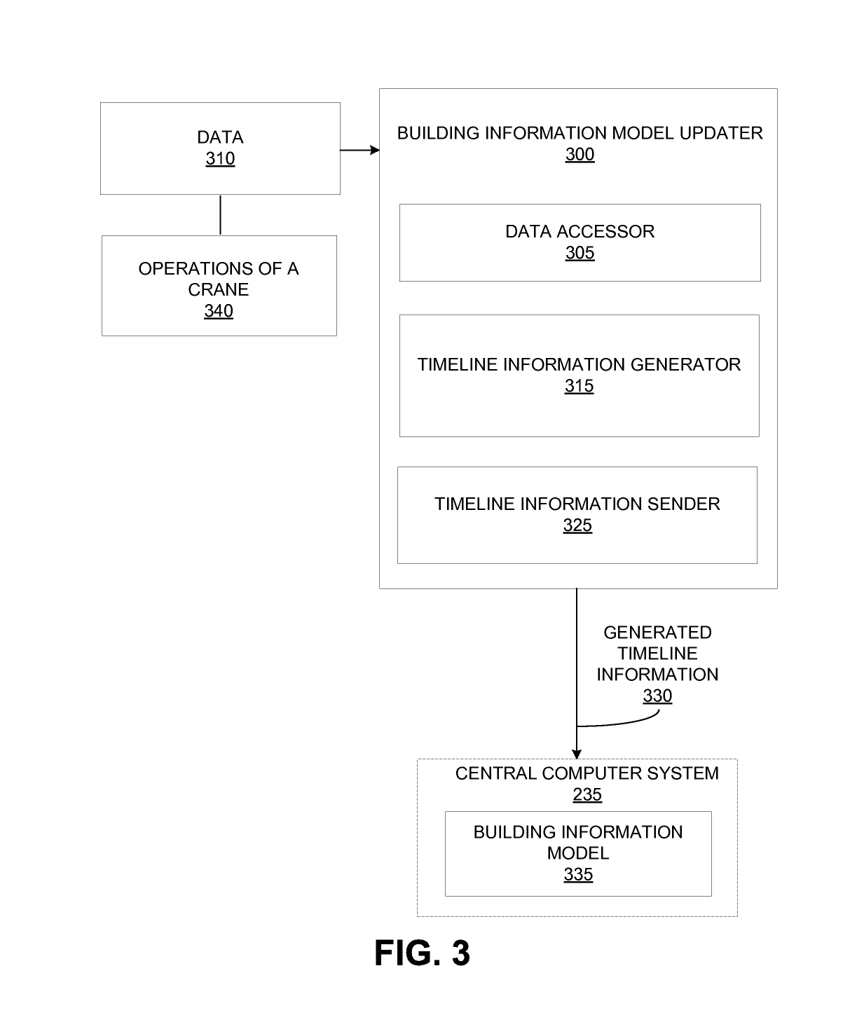

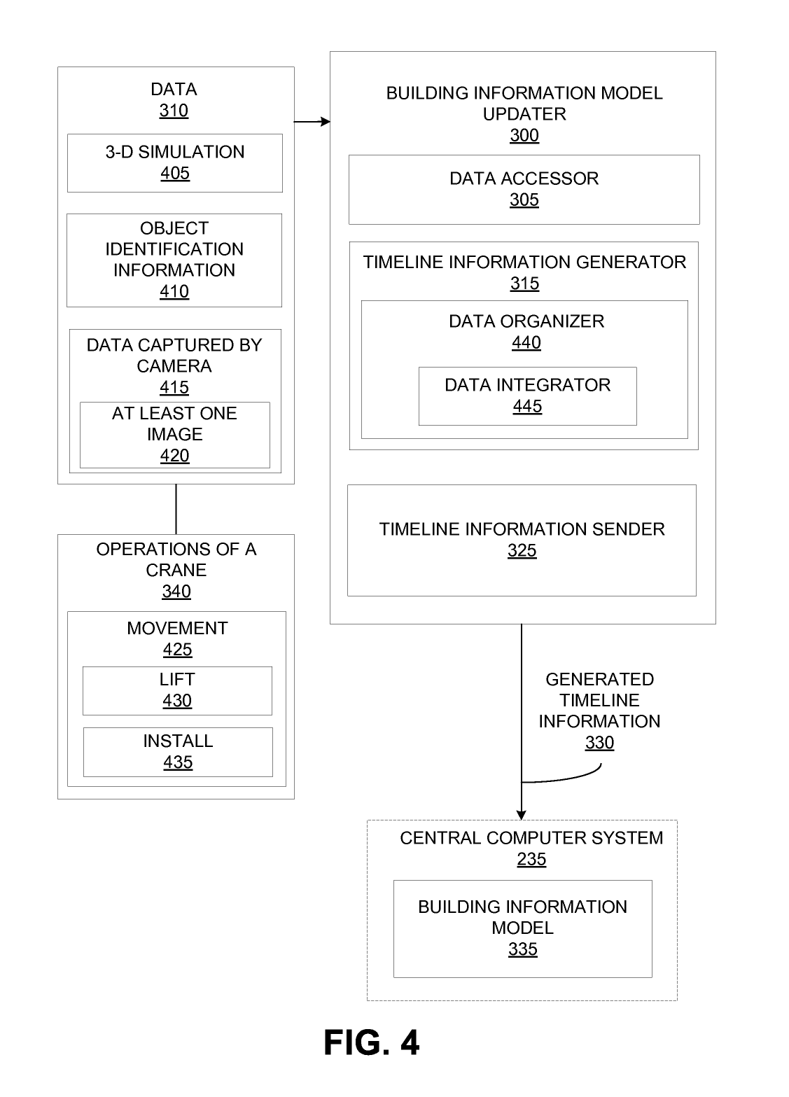

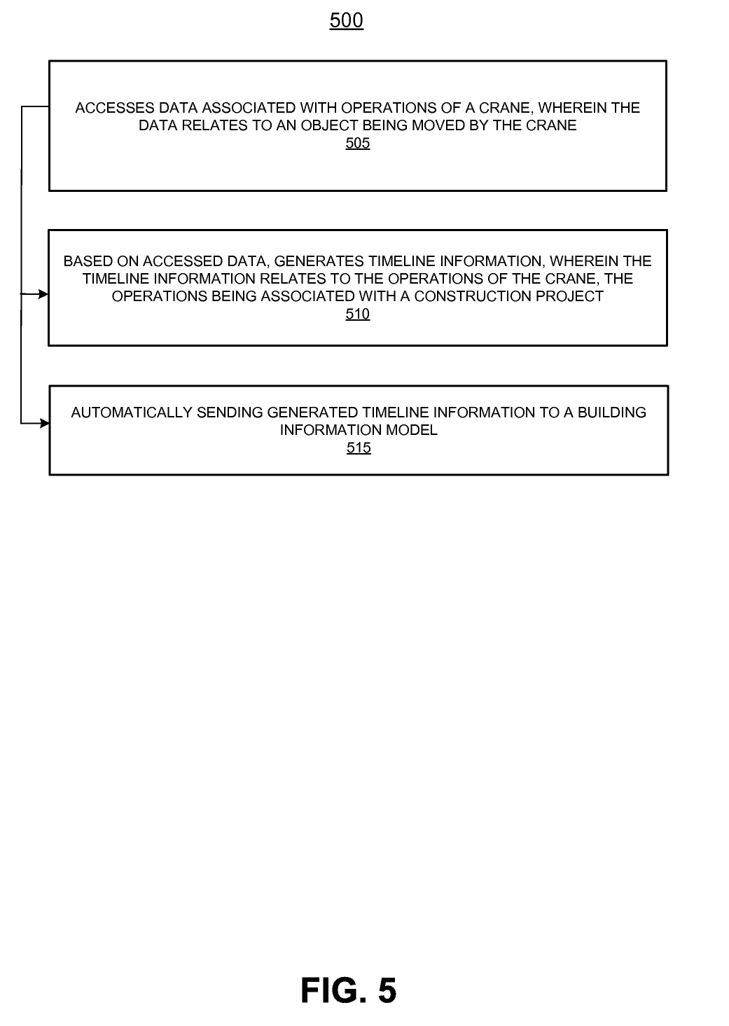

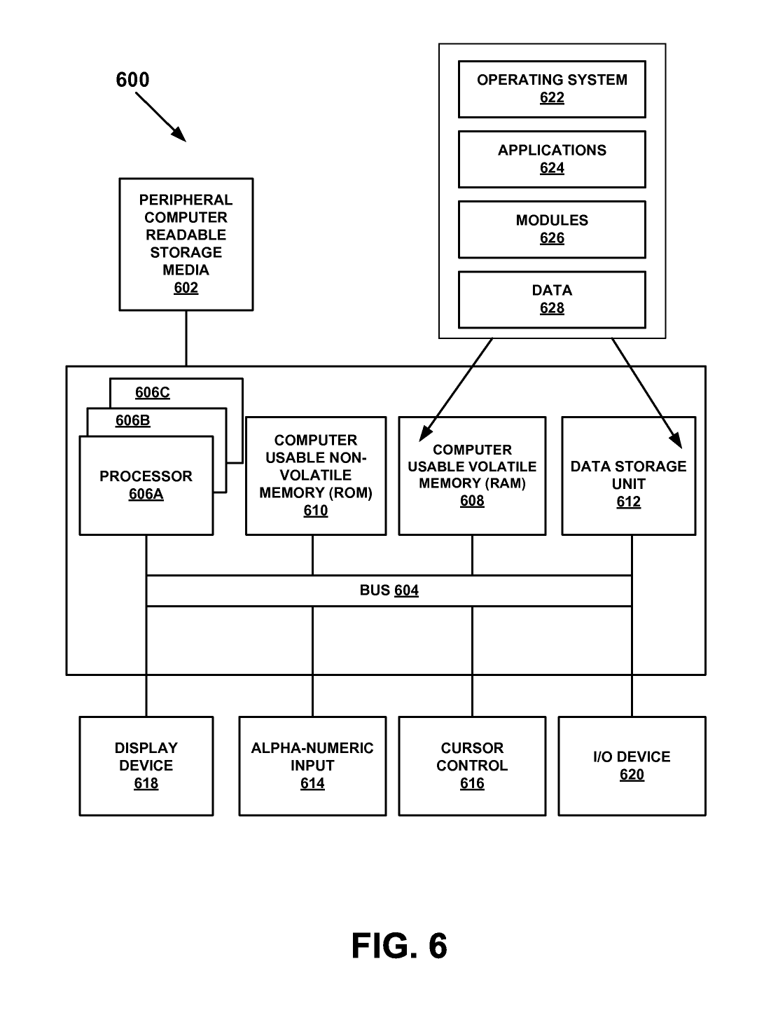

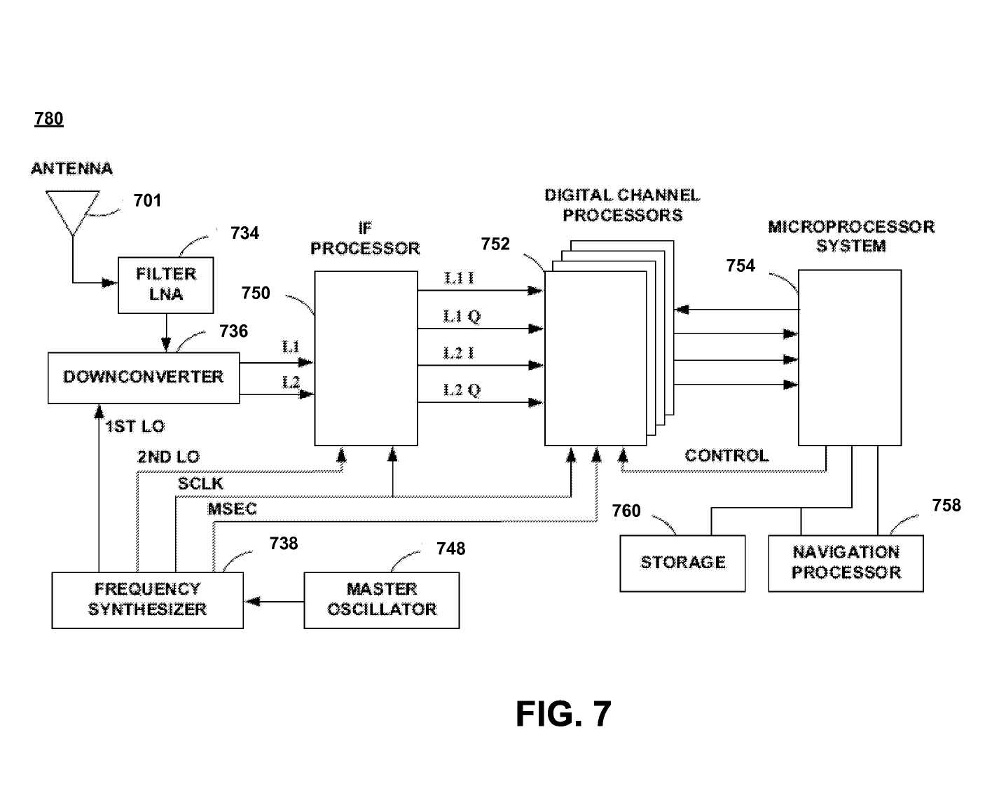

The discussion below begins with an overview of a Building Information Model and embodiments of the present technology. Then, the discussion turns to a detailed description of the following items, in accordance with various embodiments: a tower crane system and a luffer crane (See FIGS. 1A and 1B); an environment inclusive of a crane (See FIG. 2); a building model updater (See FIGS. 3 and 4); a flowchart of a method for updating a building information model with crane operations data (See FIG. 5); an example computer system upon which embodiments of the present technology may be implemented (See FIG. 6); and an example global navigation satellite system (GNSS) receiver which may be used in accordance with embodiments of the present technology (See FIG. 7).

### Overview

Building Information Modeling is a process involving the generation and management of digital representations of physical and functional characteristics of places. A Building Information Model (BIM) is a file (often, but not always, in a proprietary format and containing proprietary data) which can be exchanged or networked to support decision-making about a place. Current BIM software is used by individuals, businesses and government agencies who plan, design, construct, operate and maintain diverse physical infrastructures, such as water, wastewater, electricity, gas, refuse and communication utilities, roads, bridges, ports, houses, apartments, schools, shops, offices, factories, warehouses, prisons, etc.

Embodiments described herein provide a method for updating a BIM with timeline information relating to crane operations data with regard to a crane's movement of an object. The crane operations data may be any of the following types of data: a 3-D simulation of crane operations; an identification of an object being moved by the crane; and images captured by a camera.

The following are non-limiting examples of the different types of “movement” experienced by an object and performed by a crane: side-to-side movement; lifting movement (including an up motion and a down motion); and installing an object at a particular location (including a forward motion and a backward motion). Timeline information includes the time at which movements of an object occur, as the object's movement relates to each particular type of data accessed. In one embodiment, the timeline information includes status information. Status information, in the context of a movement of an object relating to a particular type of data accessed, refers to that particular object's movement as it relates to the construction project as a whole.

The following are some examples of an implementation of embodiments of the present technology. For instance, in a 3-D simulation, a crane moves a bundle of logs from Point “A” to Point “B” at 3:28 p.m. In one embodiment, this 3-D simulation information is stored at a central computer coupled to the crane. In another embodiment, this 3-D simulation information is stored at a server. Embodiments of the present technology access this 3-D simulation information and convert this 3-D simulation information, if necessary, into a format that is understandable by a BIM. In some embodiments, the BIM is able to understand the formatting of the accessed 3-D information, while in other embodiments, it is necessary to convert information accessed into a computer language that is understandable by the BIM. Embodiments then send this 3-D simulation information, along with the time at which it occurred (3:28 p.m.) to the BIM. Thus, the BIM is able to receive this 3-D simulation information and incorporate it as part of a timeline of 3-D movement events occurring in relation to the construction project. For example, the BIM is able to determine that the 3-D simulation of the crane's movement of the bundle of logs from Point “A” to Point “B” at 3:28 p.m. was the fifth log-lift of the morning, that approximately four log lifts remain to be performed, and that the construction area is almost cleared for the next stage of construction, which is a pouring of concrete for a foundation.

In another example, an object's movement (installation), movement timing (11:00 a.m.) and its identity (2′×4′ concrete block) are recorded. The object's movement, timing and identity are stored at a central computer coupled to the crane, in one embodiment. In another embodiment, the object's movement, timing and identity are stored at a server. Embodiments of the present technology access the information regarding the object's movement, timing and identity and convert this information, if necessary, into a format that is understandable by a BIM. Embodiments then send information regarding the object's movement, timing and identity to the BIM. The BIM is able to receive this information and incorporate it as part of a timeline of movement information occurring in relation to the construction project. For example, the BIM is able to determine that the installation of the 2′×4′ concrete block is the third concrete block to be placed in what will be a wall of three thousand concrete blocks, wherein the concrete wall will provide a “fence” surrounding an area of land. The timing of the placement of the third concrete block, at 11:00 a.m., is compared to the timing of the placement of the second concrete block, 10:50 a.m., and is compared to the timing of the placement of the first concrete block, 10:45 a.m. Among many other possible uses of this information, the BIM is then able to determine (via estimation, in one embodiment) the approximate timing of future concrete blocks, and the length of time that it will take to finish placing all three thousand concrete blocks into place. The BIM is able to create a past and future timeline of events having occurred or will be occurring at the construction site, as well as to determine the “status” of the construction project before, during, and after the recorded event of the crane's movement of the object.

In another example, a camera mounted on a crane captures the image of the object as it is being moved. It should be appreciated that camera(s) that capture the object's image may be mounted at locations other than the crane. The images captured by the camera(s), and the time at which the images were captured, may be stored at the camera itself (the camera having communication capabilities), at a central computer system coupled to the crane and/or at a server. Embodiments of the present technology access the information regarding the images taken by the camera(s) (including the time at which the images were taken) and convert this information, if necessary, into a format that is understandable by a BIM. Embodiments then send the information regarding the images to the BIM. The BIM is able to receive this information and incorporate it as part of a timeline of movement information occurring in relation to the construction project. For example, an image is taken at 2:14 p.m. showing a movement of half-full crates from Point “C” to Point “D” in a warehouse. At 2:22 p.m., an image is taken showing a movement of full crates from Point “E” to Point “C”. At 2:30, an image is taken showing the movement of the half-full crates from Point “D” to the Point “F” (the warehouse dumpster). Embodiments of the present technology access this information, and then convert it, if necessary to information that is understandable by a BIM, before sending it to the BIM. The BIM is then able to place the images in a timeline order, such that it can be shown what happened to the half-empty crates, and at what point in time these half-empty crates were thrown away.

In one embodiment, more than one event that represents the movement of the object is accessed and is presented to a BIM as an ordered sequence of events. For example, if four images in total are taken, one by each of camera one, camera two, camera three and camera four, at times 12:00 p.m., 12:02 p.m., 12:04 p.m. and 12:06 p.m., respectively, an embodiment organizes and presents these images in sequential time order to the BIM, even though the embodiment may have accessed this information from different cameras.

In one embodiment, varying types of data are accessed and integrated such that this data may be compiled and presented to a BIM as an ordered sequence of events, even though the information originated from different sources and is of a different type. For example, suppose an embodiment accesses data that includes an image that is captured at 9:00 a.m. (of 4/19/2014) of a carton of materials, identified as roofing tiles, located at Point “G”. Further, an embodiment accesses data that includes information, garnered at 9:00 a.m. (of 4/19/2014), disclosing a carton of roofing tiles being lifted onto the roof of a partially constructed warehouse. An embodiment integrates the information regarding the image of the roofing tiles at Point “G” and the information regarding the lifting of more roofing tiles onto the roof of the partially constructed warehouse, such that the totality of this information is presented to the BIM in an understandable ordered sequence of events. The BIM, for instance, may then take this information and create a timeline of events, according to its predetermined programming rules. For example, the BIM may sequentially order the existence of the carton of roofing tiles at Point “G” to be at the same time and of an equivalent priority to that of the lifting of the carton of roofing tiles onto the roof of the partially constructed warehouse. The BIM may then present this information at a display screen such that both events may be seen at the same time. However, an embodiment enables the BIM to present events that are partially in image form and/or in text form. For example, the BIM may be enabled to present the image of the carton of roofing tiles being lifted onto the roof of the partially constructed warehouse, while presenting a text describing how many cartons of tiles remain at Point “G”. Thus, an embodiment generates timeline information, via the conversion of the data associated with the operations of the crane, and transmits this timeline information to the BIM, enabling the BIM to analyze this timeline information, perform calculations using the timeline information, and present/display the timeline information in preprogrammed formats to a user (via a display screen and/or print-out).

### General Description of Crane Operation

With reference now to FIG. 1A, an illustration of a side view of a tower crane 100 is presented, according to various embodiments. The tower crane 100 may also be referred to as a “horizontal crane”.

The tower crane 100 includes a base 104, a mast 102 and a working arm (e.g., jib) 110. The mast 102 may be fixed to the base 104 or may be rotatable about base 104. The base 104 may be bolted to a concrete pad that supports the crane or may be mounted to a moveable platform. In one embodiment, the operator 132 is located in a cab 106 which includes a user interface 137.

The tower crane 100 also includes a trolley 114 which is moveable back and forth on the working arm 110 between the cab 106 and the end of the working arm 110. A cable 116 couples a hook 122 and hook block 120 to trolley 114. A counterweight 108 is on the opposite side of the working arm 110 as the trolley 114 to balance the weight of the crane components and the object being lifted, referred to hereinafter as the object 118.

The tower crane 100 also includes location sensors 124, 126, 128, and 130 which are capable of determining the location of the tower crane 100, the pointing angle of the tower crane 100, or the location of a single component of the tower crane 100. The location sensors 124, 126, 128, and 130 may be employed to determine the location of the object 118 once it is loaded onto the tower crane 100 and the location of the object 118 after it is unloaded from the tower crane 100. It should be appreciated that the tower crane 100 may employ only one location sensor or any number of location sensors to determine a location and may employ more or less locations sensors than what is depicted by FIG. 1A. Alternatively, the location of the tower crane 100 may be stationary and known to a central computer system.

In one embodiment, location sensors 124, 126, 128, and 130 are GNSS receiver antennas each capable of receiving signals from one or more global positioning system (GPS) satellites and/or other positioning satellites, as is described in greater detail in reference to FIG. 7. Each of GNSS receiver antennas are connected to, coupled with, or otherwise in communication with a GNSS receiver. In one embodiment, the GNSS receiver (e.g., GNSS receiver 150-1) may be connected or coupled to the tower crane 100. For example, any of GNSS receiver antennas may also include a separate receiver. In one embodiment, the present technology makes use of only one GNSS receiver antenna and one GNSS receiver. In one embodiment, the present technology makes use of a plurality of GNSS receiver antennas in communication with only a single GNSS receiver (e.g., GNSS receiver 150-1 or 150-2). In one embodiment, the present technology makes use of a plurality of GNSS receiver antennas in communication with a plurality of GNSS receivers. In one embodiment, the GNSS receiver (e.g., GNSS receiver 150-2) is located remote to the tower crane 100 and is in communication with the GNSS receiver antenna/antennae on the crane via a coaxial cable and/or a wireless communication link.

It should be appreciated that the location sensors 124, 126, 128, and 130 may be other types of location sensors such as mechanical or optical. A mechanical or optical sensor may have electronic or digital components that are able to transmit or send location data to a central computer system. The mechanical sensors may operate to determine a swing arm location, angle, height, etc. The mechanical sensors may be used on any component of the crane including the swing arm, the trolley, the hook, etc.

In one embodiment, a single location sensor, such as the location sensor 128, is employed to determine a pointing angle of a crane. The single location sensor collects data from at least three positions as the tower crane pivots the arm. The three locations then form a circle with the pivot at the center. Once the pivot point is known, the pointing angle of the crane can be determined using the pivot point and the current location of the single location sensor. A second sensor may then be required to determine the height of the object that is lifted. The single location sensor may be GNSS antenna and the second sensor may be a mechanical sensor.

A GNSS receiver antenna may be disposed along a point of a boom assembly of the tower crane 100. The boom assembly may be comprised of the cab 106, the counterweight 108, the working arm 110, and the trolley 114.

As depicted in FIG. 1A, a location sensor, such as a GNSS receiver antenna/antennae, may be located at various points on the tower crane 100. The location sensor 124 is located on or part of the counterweight 108. The location sensor 126 is located on or part of the trolley 114. The location sensor 128 is depicted as located on or part of the working arm 110. The location sensor 130 is depicted as located on or part of the cab 106. A location sensor may also be located on or part of the pivot point of the tower crane 100. The hook block 120 and/or the hook 122 may also be coupled with a location sensor. It should be appreciated that GNSS antennae and receivers may have errors in determining exact geographic location. Such errors may be overcome using various techniques. The error may be described in statistical terms as an error ellipsoid. The error ellipsoid defines a three-dimensional region which is expected to contain the actual position of the antenna with a given level of confidence. When the distance between the pivot point and the GNSS receiver antenna are much greater than the size of the error ellipsoid, the error in determining the actual pointing angle of the working arm of the crane is reduced.

In one embodiment, the present technology may determine locations in a local coordinate system unique to the construction site or environment. In one embodiment, the present technology may determine locations in an absolute coordinate system that applies to the whole Earth such as the coordinate system used by the Genesis system. The locations may be determined at the location sensors such as the GNSS receiver, or the location sensors may just send raw data to the central computer system where the location is determined based on the raw data.

In one embodiment, the sensor 182 is a load sensor that is able to detect that the tower crane 100 has picked up a load such as the object 118. The sensor 182 is depicted as being coupled with or located on the hook block 120. However, the sensor 182 may be located on another part or component of the tower crane 100 such as the hook 122 or the trolley 114. In one embodiment, the sensor 182 is an ID sensor configured to automatically identify the object 118. For example, the object 118 may have an RFID chip and the sensor 182 is an RFID detector or reader that can receive data from the RFID chip used to identify what type of object or material the object 118 is. The data on the RFID chip may have data such as a model number, a serial number, a product name, characteristics of the product such as weight and dimensional, installation information, technical specifications, date of manufacture, point of origin, manufacturer name, etc. The RFID chip may also contain data that points the sensor 182 to a database that comprises more data about the object 118. In one embodiment, the sensor 182 will not identify the object 118 until it has feedback that the object 118 has been loaded onto the tower crane 100. In one embodiment, the load sensor triggers the locations sensors of the tower crane 100 to send location data to the central computer system at the time the object is loaded on the crane and/or at the time the object is unloaded from the crane.

It should be appreciated that the various sensors of the tower crane 100 such as location sensors, load sensors, or ID sensors may transmit or send data directly to a central computer system or may send data to a computer system coupled with and associated with the tower crane 100 which then relays the data to the central computer system. Such transmissions may be sent over data cables or wireless connections such as Wifi, Near Field Communication (NFC), Bluetooth, cellular networks, etc.

With reference now to FIG. 1B, an illustration of a side view of the crane 160 is presented, according to various embodiments. The crane 160 may also be referred to as a luffer crane or a level luffing crane. The crane 160 may comprise some of the components described for the tower crane 100 of FIG. 1A.

The base 161 is a base or housing for components of the crane 160 such as motors, electrical components, hydraulics, etc. In one embodiment, the structure 162 comprises wheels, tracks, or other mechanics that allow for the mobility of the crane 160. In one embodiment, the structure 162 comprises outriggers that can extend or retract and are used for the stability of the crane 160. In one embodiment, the structure 162 is a platform for a stationary crane. It should be appreciated that the base 161 is able to rotate, swivel, or pivot relative to the structure 162 along the axis 167. The location sensor 163 may be disposed on top of the base 161 or may be disposed inside of the base 161. The location sensor 163 will move and rotate with the base 161 about the axis 167.

The pivot point 164 allows for the lattice boom 165 to pivot with respect to the base 161. In this manner, the lattice boom 165 can point in different directions and change the angle of the pivot point 166. The pivot point 166 allows for the jib 168 to pivot and change position with respect to the lattice boom 165 and the base 161. A location sensor may be attached to or coupled with any component of the crane 160. For example, the pivot points 164 and 166 may have a GNSS receiver antenna coupled to them. The location sensors 130, 163, 169, 170, and 171 depict various locations a location sensor may be located.

It should also be appreciated that the present technology may be implemented with a variety of cranes including, but not limited to, a tower crane, a luffing crane, a level luffing crane, a fixed crane, a mobile crane, a self-erecting crane, a crawler crane, and a telescopic crane.

With reference now to FIG. 2, an illustration of an environment 200, is shown in accordance with embodiments of the present technology. The environment 200 depicts a crane 205 which comprises the features and components of the cranes described in FIGS. 1A and 1B. It should be appreciated that the crane 205 may comprise location sensors, load sensors, and/or ID sensors. The environment 200 may be a construction site, job site or other environment where large and heavy objects are lifted and moved by lifting devices such as the crane 205. The crane 205 is capable of moving objects such as objects 215, 220, 225, and 230, in at least the following directions: side-to-side, up and down, forward and backwards. The objects 215, 220, 225, and 230 may be building material or equipment used in the construction of the structure 210. The structure 210 may be a building such as a sky scraper, office tower, house, bridge, overpass, road, etc. The objects 220 and 225 are depicted as being in a staging area where they have been delivered to be used in the construction environment. The object 215 is depicted as being lifted by the crane 205. The object 230 is depicted as being delivered by the crane 205 from the staging area to the structure 210. The object 230 may already be installed in the structure 210 or may be waiting to be installed in the structure 210. The objects 215, 220, 225, and 230 may be different types of building materials or may be the same type.

In one embodiment, the objects 215, 220, 225, and 230 are each coupled with or otherwise associated with identifiers 216, 221, 226, and 231 respectively. The identifiers 216, 221, 226, and 231 comprise information or data about the identity and characteristics of their respective objects. The data on the identifier may identify the object. This data may simply be written or inscribed on the object or a label or may be stored on an RFID chip or may be coded using bar code, quick response (QR) code, or other code. The identifier may contain the data itself or may point a user or device to a database where the data is stored. The data, or other data, may include a model number, serial number, product name, characteristics of the product such as size, shape, weight, center of gravity, rigging or equipment needed to lift the object, where the object needs to be moved to on the job site, and other characteristics that may assist a crane operator or job site manager in planning and executing the lift of the identified object, installation information, technical specifications, date of manufacture, point of origin, manufacturer name, etc.

The environment 200 depicts a rigger 240. The rigger 240 is a person associated with the job site who typically works closely with the operator of the crane 205. However, the rigger 240 as depicted in the environment 200 may represent any person or user associated with the present technology. The rigger 240 may be responsible for ensuring that an object is properly loaded or rigged for loading onto the crane 205 for lifting. The rigger 240 is depicted as carrying a handheld device 245 which is an electronic device capable of sending electronic data to the central computer system 235. In one embodiment, the handheld device 245 is a mobile computer system, a smart phone, a tablet computer, or other mobile device. The handheld device 245 may have output means such as a display and/speakers and input means such as a keyboard, touchscreen, microphone, RFID reader, camera, bar code scanner, etc. The handheld device 245 may comprise a battery for power and may send data over a wireless connection such as Wifi, Near Field Communication (NFC), Bluetooth, cellular networks, etc. The handheld device 245 may be an off-the-shelf device that may have components added to it or may be a specific purpose device built for the present technology.

The handheld device 245 may also comprise communication components that allow the rigger 240 to communicate verbally or otherwise with the operator of the crane 205 as well as other personnel such as a job foreman. In one embodiment, the handheld device 245 displays a lift plan to rigger 240 that is a schedule of what objects are to be lifted by crane 205 and in what order. Thus, the rigger 240 knows what object is to be loaded or lifted next. For example, after the object 215 is lifted, then the lift plan may inform the rigger 240 that the object 220 is to be lifted next. The rigger 240 can then identify and prepare or rig the object 220 for lifting. The handheld device 245 may assist the rigger 240 in identifying the object 220 by the handheld device 245 scanning, detecting, or otherwise reading the identifier 221. After an object is identified, the identification data may be sent to the operator of crane 205, the job foreman, the central computer system 235, and/or other places, such as the building information model updater 300 (See FIG. 3) of the present technology (discussed in detail below). In one embodiment, the building information model updater 300 is located at the central computer system 235. In one embodiment, the building information model updater 300 is located external to, communicatively coupled with, the central computer system 235. In one embodiment, after the object is identified by the rigger 240, the handheld device 245 may give the rigger 240 the opportunity to modify, verify, update, supplement, or otherwise change the identification data. Other personal may also be given the opportunity to change the data such as the operator of the crane 205 or the job foreman. The identification data may also comprise the other data regarding the characteristics of the object. In one embodiment, the rigger 240 manually enters data regarding the identity or characteristics of the object into the handheld device 245 based on data that the rigger 240 reads from a label applied to the object or based on a visual identification on the part of the rigger. The sensors associated with handheld device 245 that identify an object may be referred to as identity sensors.

In one embodiment, the handheld device 245 may be in communication with the load sensor of the crane 205 such that the identification data is not sent to building information model updater 300 and/or to the central computer system 235 until the object 220 is loaded onto the crane at which point the identification data is sent automatically. This loading may also trigger location data to be sent to the building information model updater 300 and/or the central computer system 235 simultaneously. In one embodiment, the handheld device 245 requires the rigger to authorize the identification information being sent to the building information model updater 300 and/or the central computer system 235 such that the rigger 240 may verify that the object has actually been lifted by the crane 205.

The central computer system 235, either directly or indirectly through the building information model updater 300, receives location data, load data, sensor data, identification data, etc., from the sensors associated with crane 205 and the data from the handheld device 245. The central computer system 235 is then able to track the objects for inventory purposes and other job planning purposes and/or is able to create a record for what was done at the environment 200. The record may be an installation record. In one embodiment, based on the tracking of an object, the central computer system 235 may determine that the object being lifted is being lifted out of sequence in accordance with a lift plan for crane 205 and environment 200. The central computer system 235 may then be able create an updated lift plan and send it to the crane operator, the rigger 240 and the job foreman. Once the object has been identified and a sequence of events determined, the central computer system 235 may also be able to provide additional information to the rigger, the crane operator and the job foreman to formulate a strategy for lifting the object. The central computer system 235 may receive a plurality of locations and timeline information for a single object including a first location where the object was initially lifted at a certain time by crane 205 and a second location where the object was unloaded at a certain time by the crane. The central computer system 235 may receive location data from location sensors that are not located directly on the object. However, the central computer system 235 may be able to infer the actual location of the object based on the knowledge of where the location sensor is located on the crane and where the object is lifted by the crane. For example, the central computer system 235 may receive location data from a location sensor located on a trolley of the crane 205 as well as height data from the pulley system used to lift the object via the hook on the crane 205. The combination of this data is then used to infer exactly where the object is located even though the object does not have a location sensor on it. In one embodiment, the location data is received from a lifting device at the central computer system. In one embodiment, the lifting device is a crane, as depicted in FIGS. 1A, 1B, and 2, or a forklift. The location data may be from a location sensor associated with the lifting device and may be a GNSS sensor, a mechanical sensor, or other sensor. The location of the lifting device may be fixed and known to the central computer system. The location data may be in the context of a local coordinate system or an absolute coordinate system.

It should be appreciated that the central computer system 235 maybe located at the environment 200 or located anywhere else in the world. The central computer system 235 may be more than one computer system and may have some components located in the environment 200 and others located elsewhere. In one embodiment, the central computer system 235 is a Building Information Modeling system. In one embodiment, central computer system 235 is associated with a Building Information Modeling system and is able to pull information from the Building Information Modeling system.

It should be appreciated that while FIGS. 1A, 1B, and 2 depict cranes, the present technology may also be practiced using other lifting devices such as forklifts. In accordance with the present technology, a forklift would have location sensors to generate location information about an object and possibly load sensors to generate data regarding when the object was loaded and unloaded from the forklift and possibly ID sensors to identify the object being loaded. The forklift may also be used in conjunction with a rigger and a handheld device.

### Example Building Information Model Updater

FIGS. 3 and 4 show block diagrams of an example building information model updater 300, in accordance with an embodiment. The building information model updater 300 (hereinafter, “BIM updater 300”) includes the following components coupled with a computer (See example computer 600 of FIG. 6): a data accessor 305; a timeline information generator 315; and a timeline information sender 325. In various optional embodiments, the timeline information generator 315 includes a data organizer 440, which optionally includes a data integrator 445.

The data accessor 305 accessing the data 310 associated with the operations of a crane, such as the cranes 100, 160 and 205 of FIGS. 1A, 1B and 2 discussed herein. In one embodiment, the data accessor 305 accesses the data 310 by retrieving it from various devices storing such information, such as, but not limited to, the following devices: a set of cameras (one or more cameras) coupled to the crane, object(s) to be moved, and/or to various objects within the environment 200 (e.g., ceiling, floor, wall, stationary object); the handheld device 245 of the rigger 240; the central computer system 235, the identifier 216; the load sensor 182; and the location sensor 130. In another embodiment, the data accessor 305 accesses the data 310 by receiving the data from various devices storing such information, such as, but not limited to, the following devices: a set of cameras (one or more cameras) coupled to the crane, object(s) to be moved, and/or to various objects within the environment 200 (e.g., ceiling, floor, wall, stationary object); the handheld device 245 of the rigger 240; the central computer system 235, the identifier 216; the load sensor 182; and the location sensor 130. It should be noted, and as will be described below, the BIM updater 300 sends generated timeline information to the BIM. This generated timeline information may use some, but not all, of the information received from the handheld device 245 of the rigger 240, the central computer system 235, the identifier 216, the load sensor 182, and the location sensor 130 to generate timeline information for various objects.

The data 310 relates to an object, such as object 118 of FIGS. 1A and 1B or object 215 of FIG. 2, being moved by the crane. In various embodiments, the type of movement 125 of that object being moved by the crane may be any of the following: a lifting 430 of the object; and an installing 435 of the object. As noted herein, to perform these tasks of lifting 430 and/or installing 435, an object may have to be moved from side-to-side, up and/or down, and/or forward and/or backwards. In various embodiments, the data 310 may be any of the following types of data 310: three dimensional simulation data 405; object identification information 410; and data captured by a camera 415, which optionally includes at least one image 420 that is captured by the camera.

The timeline generator 315 generates timeline information, wherein the timeline information relates to operations of a crane. The operations of the crane are associated with a construction project. In one embodiment, the data organizer 440 organizes the accessed data into a communication understandable by the building information model. The communication represents an ordered sequence of events as it relates to the accessed data.

The data organizer 440, in one embodiment, includes a data integrator 445. The data integrator 445 integrates the accessed data, wherein the accessed data includes at least two of the following types of data: a 3-D simulation of the operations of the crane; object identification information; and data captured by a camera.

The timeline information sendor 325 automatically sends the timeline information that was generated by the timeline information generator 315 to the building information model (“BIM”) 335. Of note, in one embodiment, the timeline information includes status information, as discussed herein. In one embodiment, the BIM 335 is located at the central computer system 235. In another embodiment, the BIM 335 is external to but communicatively coupled with the central computer system 235.

### Example Method for Updating a Building Information Model

With reference to FIG. 5, the process 500 is a process for updating a BIM with timeline information relating to crane operations data, according to an embodiment. In one embodiment, the process 500 is a computer implemented method that is carried out by processors and electrical components under the control of computer readable and computer executable instructions. The computer readable and computer executable instructions reside, for example, in data storage features such as computer readable volatile and non-volatile memory. However, the computer readable and computer executable instructions may reside in any type of non-transitory computer readable storage medium. In one embodiment, the process 500 is performed by components of FIGS. 1A, 1B, 2, 3 and 4. In one embodiment, the methods may reside in a non-transitory computer readable storage medium having instructions embodied therein that when executed cause a computer system to perform the method.

At 505, in one embodiment and as described herein, data associated with operations of a crane are accessed, wherein the data relates to an object being moved by the crane. The object being moved may be lifted and/or installed, and may be moved in all different directions and orientations (e.g., side-to-side, up, down, forwards, backwards, etc.). At step 505, the data is accessed by either the retrieval and/or the receipt of the data. This data may be retrieved at or received from any of, but not limited to, the following devices: a set of cameras (one or more cameras) coupled to the crane, object(s) to be moved, and/or to various objects within the environment 200 (e.g., ceiling, floor, wall, stationary object); the handheld device 245 of the rigger 240; the central computer system 235, the identifier 216; the load sensor 182; and the location sensor 130.

The data that is associated with the operations of a crane includes any of the following types of data: 3-D simulations data; object identification information; and data captured by cameras. For example, in one embodiment, the 3-D simulation data is created at the central computer system 235 and/or at some other accessible computer. The 3-D simulation data is a simulation of various crane operations being performed, such as, a simulation of a lift schedule (including location and time of lift and size and weight of object(s) being lifted). In one embodiment, the object identification information is accessed at a handheld device 245 held by the rigger 240. In another embodiment, embodiments retrieve the information from the handheld device 245.

In one embodiment, the object identification information is accessed from various devices within the environment 200, such as identity sensors, including, but not limited to being, the following types of devices: an RFID detector or reader; a bar code scanner; a QR scanner or camera. These types of identity sensors are generally known in the art, and will not be explained in further detail herein.

In another embodiment, the data captured by a set of cameras includes images of objects being moved about the environment 200. The images themselves may be sent to the BIM and/or the central computer system 235, in one embodiment. These images may then be presented to the viewer, in sequential order, alone or in combination with other images taken by the set of cameras and/or other types of data.

In another embodiment, once an object is identified by the identity sensors known in the art, an embodiment of the present technology may confirm or invalidate such an identity. For example, a camera is attached to the ceiling of warehouse. The camera takes pictures of the events occurring in the warehouse every two minutes. Embodiments access these images, and compare an image “P” taken of the top view of an object (such as, for example, a box of packaged waters) and compares it to a database of images. The database of images may be located at the BIM updater 300, the central computer system 235, and/or at the camera itself. Once a match is found between image “P” and an image in the database, wherein item names within the database of images correlate with the different images therein, the image is determined to be, in this example, a box of packaged waters. Of note, depending on the vantage point at which a camera is placed, an object may be different but may look the same in a given photo image of the object from a certain viewing perspective; for example, two different objects may look the same from a top down viewing perspective, but look different from a side viewing perspective. Therefore, the camera data in accordance with embodiments, may only be sued as a possible confirmation of an object's identity, but may be used to definitively deny a confirmation if the object looks different than what an object should look like compared to identifications made by identity sensors.

Continuing with the example of the image “P” being accessed, the identification of the object made by the identity sensor(s) is accessed. Embodiments compare 1) the identity of the object as determined by comparing the overhead image “P” to a database of images with 2) the identity as determined by the identity sensor. If the two identities of 1) and 2) match, then the identity of the object as determined by the identity sensor is confirmed. However, if the two identities of 1) and 2) do not match, then embodiments invalidate the identity of the object as determined by the identity sensor. For example, if the comparison of the overhead image to a database of images results in the determination that the object is a box of packaged waters, and the identity sensor determines that the same object is a box of tissues, then embodiments invalidate the identification made by the identity sensor.

At 510, in one embodiment and as described herein, timeline information is generated, wherein the timeline information relates to the operations of the crane, wherein the operations of the crane are associated with a construction project (e.g., building under construction, fencing project, landscaping project, etc.). As noted herein, timeline information includes the time at which movements of an object occur, as the object's movement relates to each particular type of data accessed.

In one embodiment, accessing the timeline information includes accessing status information. As noted herein, status information, in the context of a movement of an object relating to a particular type of data accessed, refers to that particular object's movement as it relates to the construction project as a whole. For example, status information may describe the progress of the construction project, and at what point within the totality of the construction project that a particular movement of an object occurs. Thus, in one embodiment, the status information displays a movement of an object in the context of the totality of the project. For example, if fencing material is moved from Point “R” to Point “S” at 4:14 p.m. on a Tuesday, the status information may show that the movement of the fencing material has occurred at a point that is at the beginning of the fencing project but is ⅔ through the entire construction project. It should be appreciated that status information may be any type of information that provides a description (via visual and/or audio means) of a particular event (e.g., a lifting an object of a set of similar objects, a tiling phase of a construction project) as it relates to a larger or smaller event (e.g., moving the set of similar objects, completing the entire construction, moving tiles from one location to another location on the construction site).

In one embodiment and as described herein, the generating the timeline information at step 510 includes organizing accessed data into a communication understandable by the BIM, wherein the communication represents an ordered sequence of events as it relates to the accessed data. In one embodiment and as described herein, the organizing the accessed data includes integrating the accessed data, wherein the accessed data includes at least two of the following types of data: a 3-D simulation of the operations of the crane; object identification information; and data captured by a camera.

In one embodiment, the generating of the timeline information at step 510 includes time stamping the accessed data according to a time at which the object is understood to have been moved by the operations of the crane. The time stamping is performed, in one embodiment, by a time stamper located at the BIM updater 300. For example, in one embodiment, crane operations, identity sensors, computers performing 3-D simulation of crane operations and cameras taking images of crane operations are continuously monitored. In one embodiment, the BIM updater 300 continuously monitors the identity sensors, computers performing 3-D simulation of crane operations and cameras taking images of crane operations. In one embodiment, embodiments access, in real-time, data associated with operations of the crane provided by the identity sensors and the cameras, and provide a time stamp on the data that is accessed. The term, “real-time” in the context of accessing data, in real-time, provided by the identity sensors, 3-D simulations, and cameras taking images of crane operations, refers to accessing the data as close to the time that the event was recorded (identity determined, image captured, simulation performed) as is possible. Embodiments use this time stamp to determine the sequential order of the events. The events occurring in the 3-D simulation are time stamped during the simulation.

At step 515, in one embodiment and as described herein, the generated timeline information is automatically sent to the BIM. That is, in one embodiment, the BIM updater 300 sends the timeline information that was generated at step 510, without prompting from an external source. The generated timeline information is sent once it is generated. Thus, if the BIM updater 300 is continuously monitoring, in real-time or some other fixed and continuous periodic timing, the crane operations as it relates to an object being moved by the crane, the BIM will be updated at approximately the time at which the data associated with the operations of a crane are accessed (See step 505). Thus, embodiments enable a BIM to be automatically updated throughout a construction project's term.

### Computer System

With reference now to FIG. 6, portions of the technology for providing a communication composed of computer readable and computer-executable instructions that reside, for example, in non-transitory computer-usable storage media of a computer system. That is, FIG. 6 illustrates one example of a type of computer that can be used to implement embodiments of the present technology, such as the handheld device 245, central computer system 235 of FIG. 2 and the BIM updater 300 of FIGS. 3 and 4. FIG. 6 represents a system or components that may be used in conjunction with aspects of the present technology. In one embodiment, some or all of the components of FIGS. 1A, 1B, 2, 3 and 4 may be combined with some or all of the components of FIG. 6 to practice the present technology.

FIG. 6 illustrates an example computer system 600 used in accordance with embodiments of the present technology. It is appreciated that system 600 of FIG. 6 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 6, computer system 600 of FIG. 6 is well adapted to having peripheral computer readable media 602 such as, for example, a floppy disk, a compact disc, and the like coupled thereto.

System 600 of FIG. 6 includes an address/data bus 604 for communicating information, and a processor 606A coupled to bus 604 for processing information and instructions. As depicted in FIG. 6, system 600 is also well suited to a multi-processor environment in which a plurality of processors 606A, 606B, and 606C are present. Conversely, system 600 is also well suited to having a single processor such as, for example, processor 606A. Processors 606A, 606B, and 606C may be any of various types of microprocessors. System 600 also includes data storage features such as a computer usable volatile memory 608, e.g. random access memory (RAM), coupled to bus 604 for storing information and instructions for processors 606A, 606B, and 606C.

System 600 also includes computer usable non-volatile memory 610, e.g. read only memory (ROM), coupled to bus 604 for storing static information and instructions for processors 606A, 606B, and 606C. Also present in system 600 is a data storage unit 612 (e.g., a magnetic or optical disk and disk drive) coupled to bus 604 for storing information and instructions. System 600 also includes an optional alpha-numeric input device 614 including alphanumeric and function keys coupled to bus 604 for communicating information and command selections to processor 606A or processors 606A, 606B, and 606C. System 600 also includes an optional cursor control device 616 coupled to bus 604 for communicating user input information and command selections to processor 606A or processors 606A, 606B, and 606C. System 600 of the present embodiment also includes an optional display device 618 coupled to bus 604 for displaying information.

Referring still to FIG. 6, optional display device 618 of FIG. 6 may be a liquid crystal device, cathode ray tube, plasma display device, light emitting diode (LED) light-bar, or other display device suitable for creating graphic images and alpha-numeric characters recognizable to a user. Optional cursor control device 616 allows the computer user to dynamically signal the movement of a visible symbol (cursor) on a display screen of display device 618. Many implementations of cursor control device 616 are known in the art including a trackball, mouse, touch pad, joystick or special keys on alpha-numeric input device 614 capable of signaling movement of a given direction or manner of displacement. Alternatively, it will be appreciated that a cursor can be directed and/or activated via input from alpha-numeric input device 614 using special keys and key sequence commands.

System 600 is also well suited to having a cursor directed by other means such as, for example, voice commands. System 600 also includes an I/O device 620 for coupling system 600 with external entities. For example, in one embodiment, I/O device 620 is a modem for enabling wired or wireless communications between system 600 and an external network such as, but not limited to, the Internet. A more detailed discussion of the present technology is found below.

Referring still to FIG. 6, various other components are depicted for system 600. Specifically, when present, an operating system 622, applications 624, modules 626, and data 628 are shown as typically residing in one or some combination of computer usable volatile memory 608, e.g. random access memory (RAM), and data storage unit 612. However, it is appreciated that in some embodiments, operating system 622 may be stored in other locations such as on a network or on a flash drive; and that further, operating system 622 may be accessed from a remote location via, for example, a coupling to the internet. In one embodiment, the present technology, for example, is stored as an application 624 or module 626 in memory locations within RAM 608 and memory areas within data storage unit 612. The present technology may be applied to one or more elements of described system 600.

System 600 also includes one or more signal generating and receiving device(s) 630 coupled with bus 604 for enabling system 600 to interface with other electronic devices and computer systems. Signal generating and receiving device(s) 630 of the present embodiment may include wired serial adaptors, modems, and network adaptors, wireless modems, and wireless network adaptors, and other such communication technology. The signal generating and receiving device(s) 630 may work in conjunction with one or more communication interface(s) 632 for coupling information to and/or from system 600. Communication interface 632 may include a serial port, parallel port, Universal Serial Bus (USB), Ethernet port, antenna, or other input/output interface. Communication interface 632 may physically, electrically, optically, or wirelessly (e.g. via radio frequency) couple system 600 with another device, such as a cellular telephone, radio, or computer system.

The computing system 600 is only one example of a suitable computing environment and is not intended to suggest any limitation as to the scope of use or functionality of the present technology. Neither should the computing environment be interpreted as having any dependency or requirement relating to any one or combination of components illustrated in the example computing system 600.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

### GNSS Receiver

With reference now to FIG. 7, a block diagram is shown of an embodiment of an example GNSS receiver which may be used in accordance with various embodiments described herein. In particular, FIG. 7 illustrates a block diagram of a GNSS receiver in the form of a general purpose GPS receiver 780 capable of demodulation of the L1 and/or L2 signal(s) received from one or more GPS satellites. For the purposes of the following discussion, the demodulation of L1 and/or L2 signals is discussed. It is noted that demodulation of the L2 signal(s) is typically performed by “high precision” GNSS receivers such as those used in the military and some civilian applications. Typically, the “consumer” grade GNSS receivers do not access the L2 signal(s). Further, although L1 and L2 signals are described, they should not be construed as a limitation to the signal type; instead, the use of the L1 and L2 signal(s) is provided merely for clarity in the present discussion.

Although an embodiment of a GNSS receiver and operation with respect to GPS is described herein, the technology is well suited for use with numerous other GNSS signal(s) including, but not limited to, GPS signal(s), Glonass signal(s), Galileo signal(s), and BeiDou signal(s).

The technology is also well suited for use with regional navigation satellite system signal(s) including, but not limited to, Omnistar signal(s), StarFire signal(s), Centerpoint signal(s), Doppler orbitography and radio-positioning integrated by satellite (DORIS) signal(s), Indian regional navigational satellite system (IRNSS) signal(s), quasi-zenith satellite system (QZSS) signal(s), and the like.

Moreover, the technology may utilize various satellite based augmentation system (SBAS) signal(s) such as, but not limited to, wide area augmentation system (WAAS) signal(s), European geostationary navigation overlay service (EGNOS) signal(s), multi-functional satellite augmentation system (MSAS) signal(s), GPS aided geo augmented navigation (GAGAN) signal(s), and the like.

In addition, the technology may further utilize ground based augmentation systems (GBAS) signal(s) such as, but not limited to, local area augmentation system (LAAS) signal(s), ground-based regional augmentation system (GRAS) signals, Differential GPS (DGPS) signal(s), continuously operating reference stations (CORS) signal(s), and the like.

Although the example herein utilizes GPS, the present technology may utilize any of the plurality of different navigation system signal(s). Moreover, the present technology may utilize two or more different types of navigation system signal(s) to generate location information. Thus, although a GPS operational example is provided herein it is merely for purposes of clarity.

In one embodiment, the present technology may be utilized by GNSS receivers which access the L1 signals alone, or in combination with the L2 signal(s). A more detailed discussion of the function of a receiver such as GPS receiver 780 can be found in U.S. Pat. No. 5,621,426. U.S. Pat. No. 5,621,426, by Gary R. Lennen, entitled “Optimized processing of signals for enhanced cross-correlation in a satellite positioning system receiver,” which includes a GPS receiver very similar to GPS receiver 780 of FIG. 7.

In FIG. 7, received L1 and L2 signal is generated by at least one GPS satellite. Each GPS satellite generates different signal L1 and L2 signals and they are processed by different digital channel processors 752 which operate in the same way as one another. FIG. 7 shows GPS signals (L1=1575.42 MHz, L2=1227.60 MHz) entering GPS receiver 780 through a dual frequency antenna 701. Antenna 701 may be a magnetically mountable model commercially available from Trimble® Navigation of Sunnyvale, Calif, 94085. Master oscillator 748 provides the reference oscillator which drives all other clocks in the system. Frequency synthesizer 738 takes the output of master oscillator 748 and generates important clock and local oscillator frequencies used throughout the system. For example, in one embodiment frequency synthesizer 738 generates several timing signals such as a 1st LO1 (local oscillator) signal 1400 MHz, a 2nd LO2 signal 175 MHz, a (sampling clock) SCLK signal 25 MHz, and a MSEC (millisecond) signal used by the system as a measurement of local reference time.

A filter/LNA (Low Noise Amplifier) 734 performs filtering and low noise amplification of both L1 and L2 signals. The noise figure of GPS receiver 780 is dictated by the performance of the filter/LNA combination. The downconverter 736 mixes both L1 and L2 signals in frequency down to approximately 175 MHz and outputs the analogue L1 and L2 signals into an IF (intermediate frequency) processor 30. If processor 750 takes the analog L1 and L2 signals at approximately 175 MHz and converts them into digitally sampled L1 and L2 inphase (L1 I and L2 I) and quadrature signals (L1 Q and L2 Q) at carrier frequencies 420 KHz for L1 and at 2.6 MHz for L2 signals respectively.

At least one digital channel processor 752 inputs the digitally sampled L1 and L2 inphase and quadrature signals. All digital channel processors 752 are typically identical by design and typically operate on identical input samples. Each digital channel processor 752 is designed to digitally track the L1 and L2 signals produced by one satellite by tracking code and carrier signals and to form code and carrier phase measurements in conjunction with the microprocessor system 754. One digital channel processor 752 is capable of tracking one satellite in both L1 and L2 channels.

Microprocessor system 754 is a general purpose computing device which facilitates tracking and measurements processes, providing pseudorange and carrier phase measurements for a navigation processor 758. In one embodiment, microprocessor system 754 provides signals to control the operation of one or more digital channel processors 752. Navigation processor 758 performs the higher level function of combining measurements in such a way as to produce position, velocity and time information for the differential and surveying functions. Storage 760 is coupled with navigation processor 758 and microprocessor system 754. It is appreciated that storage 760 may comprise a volatile or non-volatile storage such as a RAM or ROM, or some other computer readable memory device or media.

One example of a GPS chipset upon which embodiments of the present technology may be implemented is the Maxwell™ chipset which is commercially available from Trimble® Navigation of Sunnyvale, Calif., 94085.

Differential GPS

Embodiments described herein can use Differential GPS to determine position information with respect to a jib of the tower crane. Differential GPS (DGPS) utilizes a reference station which is located at a surveyed position to gather data and deduce corrections for the various error contributions which reduce the precision of determining a position fix. For example, as the GNSS signals pass through the ionosphere and troposphere, propagation delays may occur. Other factors which may reduce the precision of determining a position fix may include satellite clock errors, GNSS receiver clock errors, and satellite position errors (ephemeredes).

The reference station receives essentially the same GNSS signals as rovers which may also be operating in the area. However, instead of using the timing signals from the GNSS satellites to calculate its position, it uses its known position to calculate errors in the respective satellite measurements. The reference station satellite errors, or corrections, are then broadcast to rover GNSS equipment working in the vicinity of the reference station. The rover GNSS receiver applies the reference station satellite corrections to its respective satellite measurements and in so doing, removes many systematic satellite and atmospheric errors. As a result, the rover GNSS receiver position estimates are more precisely determined. Alternatively, the reference station corrections may be stored for later retrieval and correction via post-processing techniques.

### Real Time Kinematic System

An improvement to DGPS methods is referred to as Real-time Kinematic (RTK). The present technology employs RTK, however, in one embodiment, the working angle of the crane is determined without using RTK. As in the DGPS method, the RTK method, utilizes a reference station located at determined or surveyed point. The reference station collects data from the same set of satellites in view by the rovers in the area. Measurements of GNSS signal errors taken at the reference station (e.g., dual-frequency code and carrier phase signal errors) and broadcast to one or more rovers working in the area. The rover(s) combine the reference station data with locally collected carrier phase and pseudo-range measurements to estimate carrier-phase ambiguities and precise rover position. The RTK method is different from DGPS methods primarily because RTK is based on precise GNSS carrier phase measurements. DGPS methods are typically based on pseudo-range measurements. The accuracy of DGPS methods is typically decimeter-to meter-level; whereas RTK techniques typically deliver cm-level position accuracy.

RTK rovers are typically limited to operating within 70 km of a single reference station, Atmospheric errors such as ionospheric and tropospheric errors become significant beyond 70 km. “Network RTK” or “Virtual Reference Station” (VRS) techniques have been developed to address some of the limitations of single-reference station RTK methods.

### Network RTK

Network RTK typically uses three or more GNSS reference stations to collect GNSS data and extract spatial and temporal information about the atmospheric and satellite ephemeris errors affecting signals within the network coverage region. Data from all the various reference stations is transmitted to a central processing facility, or control center for Network RTK. Suitable software at the control center processes the reference station data to infer how atmospheric and/or satellite ephemeris errors vary over the region covered by the network. The control center computer then applies a process which interpolates the atmospheric and/or satellite ephemeris errors at any given point within the network coverage area. Synthetic pseudo-range and carrier phase observations for satellites in view are then generated for a “virtual reference station” nearby the rover(s).

The rover is configured to couple a data-capable cellular telephone to its internal signal processing system. The surveyor operating the rover determines that he needs to activate the VRS process and initiates a call to the control center to make a connection with the processing computer. The rover sends its approximate position, based on raw GNSS data from the satellites in view without any corrections, to the control center. Typically, this approximate position is accurate to approximately 4-7 meters. The surveyor then requests a set of “modeled observables” for the specific location of the rover. The control center performs a series of calculations and creates a set of correction models that provide the rover with the means to estimate the ionospheric path delay from each satellite in view from the rover, and to take into account other error contributions for those same satellites at the current instant in time for the rover's location. In other words, the corrections for a specific rover at a specific location are determined on command by the central processor at the control center and a corrected data stream is sent from the control center to the rover. Alternatively, the control center may instead send atmospheric and ephemeris corrections to the rover which then uses that information to determine its position more precisely.

These corrections are now sufficiently precise that the high performance position accuracy standard of 2-3 cm may be determined, in real time, for any arbitrary rover position. Thus the GNSS rover's raw GNSS data fix can be corrected to a degree that makes it behave as if it were a surveyed reference location; hence the terminology “virtual reference station.” An example of a network RTK system which may be utilized in accordance with embodiments described herein is described in U. S. Pat. No. 5,899,957, entitled “Carrier Phase Differential GPS Corrections Network,” by Peter Loomis, assigned to the assignee of the present patent application.

The Virtual Reference Station method extends the allowable distance from any reference station to the rovers. Reference stations may now be located hundreds of kilometers apart, and corrections can be generated for any point within an area surrounded by reference stations.

Although the subject matter is described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What we claim is:

1. A method for updating a building information model with timeline information relating to crane operations data, said method comprising:
accessing data associated with operations of a crane, wherein said data relates to an object being moved by said crane;
based on accessed data, generating timeline information, wherein said timeline information relates to said operations of said crane, said operations associated with a construction project; and
automatically sending generated timeline information to said building information model.

2. The method as recited in claim 1, wherein said accessing data comprises:
accessing data associated with operations of a crane, wherein said data relates to an object being lifted by said crane.

3. The method as recited in claim 1, wherein said accessing data comprises:
accessing data associated with operations of a crane, wherein said data relates to an object being installed by said crane.

4. The method as recited in claim 1, wherein said accessing data comprises:
accessing 3-D simulation data.

5. The method as recited in claim 1, wherein said accessing data comprises:
accessing object identification information.

6. The method as recited in claim 1, wherein said accessing data comprises:
accessing data captured by a camera.

7. The method as recited in claim 1, wherein said generating timeline information comprises:
generating status information.

8. The method as recited in claim 1, wherein said generating timeline information comprises:
organizing said accessed data into a communication understandable by said building information model, wherein said communication represents an ordered sequence of events as it relates to said accessed data.

9. The method as recited in claim 8, wherein said organizing said accessed data comprises:
integrating said accessed data, wherein said accessed data comprises at least two of the following types of data: a 3-D simulation of said operations of said crane;
object identification information; and data captured by a camera.

10. The method as recited in claim 1, wherein said generating timeline information comprises:
time stamping said accessed data according to a time at which said object is understood to have been moved by said operations of said crane.

11. A building information model updater for updating a building information model with timeline information relating to crane operations data, said building information model updater comprising:
a data accessor coupled to a computer, said data accessor configured for accessing data associated with operations of a crane, wherein said data relates to an object being moved by said crane;
a timeline information generator coupled to said computer, said timeline information generator configured for, based on accessed data, generating timeline information, wherein said timeline information relates to said operations of said crane, said operations associated with a construction project; and
a timeline information sender coupled to said computer, said timeline information sender configured for automatically sending generated timeline information to said building information model.

12. The building information model updater as recited in claim 11, wherein said data relating to said object being moved by said crane comprises:
data relating to said object being lifted by said crane.

13. The building information model updater as recited in claim 11, wherein said data relating to said object being moved by said crane comprises:
data relating to said object being installed by said crane.

14. The building information model updater as recited in claim 11, wherein said data comprises:
3-D simulation data.

15. The building information model updater as recited in claim 11, wherein said data comprises:
object identification information.

16. The building information model updater as recited in claim 11, wherein said data comprises:
data captured by a camera.

17. The building information model updater as recited in claim 16, wherein said data captured by said camera comprises:
at least one image.

18. The building information model updater as recited in claim 11, wherein said timeline information generator comprises:
a data organizer coupled to said computer, said data organizer configured for organizing said accessed data into a communication understandable by said building information model, wherein said communication represents an ordered sequence of events as it relates to said accessed data.

19. The building information model updater as recited in claim 18, wherein said data organizer comprises:
a data integrator configured for integrating said accessed data, wherein said accessed data comprises at least two of the following types of data: a 3-D simulation of said operations of said crane; object identification information; and data captured by a camera.

20. A non-transitory computer readable storage medium having instructions embodied therein that when executed cause a computer system to perform a method for updating a building information model with timeline information relating to crane operations data, said method comprising:
accessing data associated with operations of a crane, wherein said data relates to an object being moved by said crane;
based on accessed data, generating timeline information, wherein said timeline information relates to said operations of said crane, said operations associated with a construction project; and
automatically sending generated timeline information to said building information model.
